(19) United States
(12) Patent Application Publication
(10) Pub. No.: US 2015/0220907 A1
(43) Pub. Date: Aug. 6, 2015

(54) Authorization of Transactions

(71) Applicant: Mashinery Pty Ltd., Surry Hills NSW (AU)

(72) Inventors: Matthew Charles Denton, Bronte (AU); David Albert Barda, Rose Bay (AU)

(21) Appl. No.: 14/414,888

(22) PCT Filed: Jul. 16, 2013
(86) PCT No.: PCT/IB2013/002032

§ 371 Date: Jan. 14, 2015

Related U.S. Application Data
(60) Provisional application No. 61/671,916, filed on Jul. 16, 2012.

(51) Int. Cl. G06Q 20/32; G06Q 20/40

(52) U.S. Cl. CPC G06Q 20/3224; G06Q 20/405

(57) ABSTRACT

When an authentication system receives a request to determine whether to authorize a transaction, the authentication identifies one or more rules applicable to the transaction. The authentication system determines whether conditions of the applicable rules are satisfied based on historical authentication information received from a mobile device of a user involved in the transaction. The historical information is generated by the mobile device prior to receiving the request and based on a limited-range connection between the mobile device and authentication system. The authentication system authorizes or denies the transaction based on whether the conditions of the applicable rules are satisfied.

### CROSS-REFERENCE TO RELATED APPLICATIONS

This application claims the benefit of provisional application 61/671,916, filed on Jul. 16, 2012, which is incorporated by reference in its entirety.

### BACKGROUND

1. Technical Field

The described embodiments pertain in general to authorizing transactions, and in particular to determining whether to authorize a transaction based on historical authentication information.

2. Description of the Related Art

Today, people are easily able to initiate different types of financial transactions electronically. For example, a person can electronically request to purchase items from a merchant or request to transfer funds from one bank account to another. Typically, a requester is authenticated using a password, a personal identification number (PIN), or by answering a security question. In some situations, the requester is authenticated by possessing a card (e.g., a credit card) with the account information of an account. Despite these authentication methods, millions of transactions still occur every year where unauthorized individuals initiate fraudulent transactions.

### SUMMARY

Described embodiments facilitate authorization of transactions by relying on historical authentication information obtained prior to receiving a request for authorizing a transaction. A limited-range wireless connection, or tether, is established between a mobile device (e.g., a mobile phone) and an authentication device of a user. The authentication device may be, for example, in the form of a card that can be carried in a wallet of the user, a token carried in a keychain or another type of computing device.

The authentication device transmits periodic messages to the mobile device via the connection (e.g., every two seconds). The mobile device generates authentication information based on the messages or lack of messages received from the authentication device. The mobile device may, for example, generate the authentication information periodically (e.g., every minute or after every third messages received) or after every message received from the authentication device.

The generated authentication information is related to the connection and may be used in determining whether to authorize a transaction. The authentication information may be, for example, a time when the last message was received by the mobile device from the authentication module, an indication as to whether the limited range connection between the devices is still active, an IP address of the mobile device when the last message was received from the authentication device, and a signal strength of the last message received.

The mobile device transmits the generated authentication information to an authentication system. The authentication system stores the information as historical authentication information which may be used in determining whether to authorize a transaction.

When the authentication system receives from a transaction system a request to determine whether to authorize a transaction, the authentication system identifies characteristics of the transaction (e.g., amount of the transaction, a location where the transaction was initiated, a type of the transaction) and the user involved in the transaction. The authentication system identifies one or more rules applicable to the transaction. The rules applicable to the transaction reflect a degree of risk of the transaction. For example, more stringent rules may be applied to a purchase transaction of items for a large amount of money, while more lenient rules may be applied to a purchase transaction for a small beverage.

The authentication system determines whether the conditions of the applicable rules are satisfied. A determination as to whether the conditions of one or more rules are satisfied may be made based on historical authentication information received from the user's mobile device. For example, the conditions of a rule may be satisfied if the historical authentication information indicates that within the last hour, the user's mobile device and authentication device have been connected via the limited-range connection for at least 70% of the time. As another example, the conditions of a rule may be satisfied if the historical authentication information indicates that the IP address of the mobile device in the last 15 minutes is the same as the IP address used to initiate the transaction.

The conditions of one or more rules may also require that the mobile device perform an authentication process. An authentication process may require, for example, that the mobile device generate current authentication information, request that the user provide personal information to authorize the transaction (e.g., a password or a personal identification number (PIN)), or request that the user perform a gesture with the authentication device to authorize the transaction (e.g., perform a sweeping action with the authentication device above the mobile device).

The authentication system authorizes or denies the transaction based on whether the conditions of the applicable rules are satisfied. The authentication system notifies the transaction system of its authorization or denial of the transaction.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is a block diagram of an authentication environment 100 according to one embodiment.

FIG. 2 is a block diagram illustrating a functional view of a typical computer system for use as a mobile device, an authorization system and/or a transaction system according to one embodiment.

FIG. 3 is a block diagram illustrating modules within a security module according to one embodiment.

FIG. 4 is a block diagram illustrating modules within an authorization system according to one embodiment.

FIG. 5 illustrates an interaction diagram of a process for monitoring a limited-range connection between an authentication device and a mobile device according to one embodiment.

FIG. 6 is a flowchart illustrating steps performed by the authorization system 104 in processing a request to determine whether to authorize a transaction according to one embodiment.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

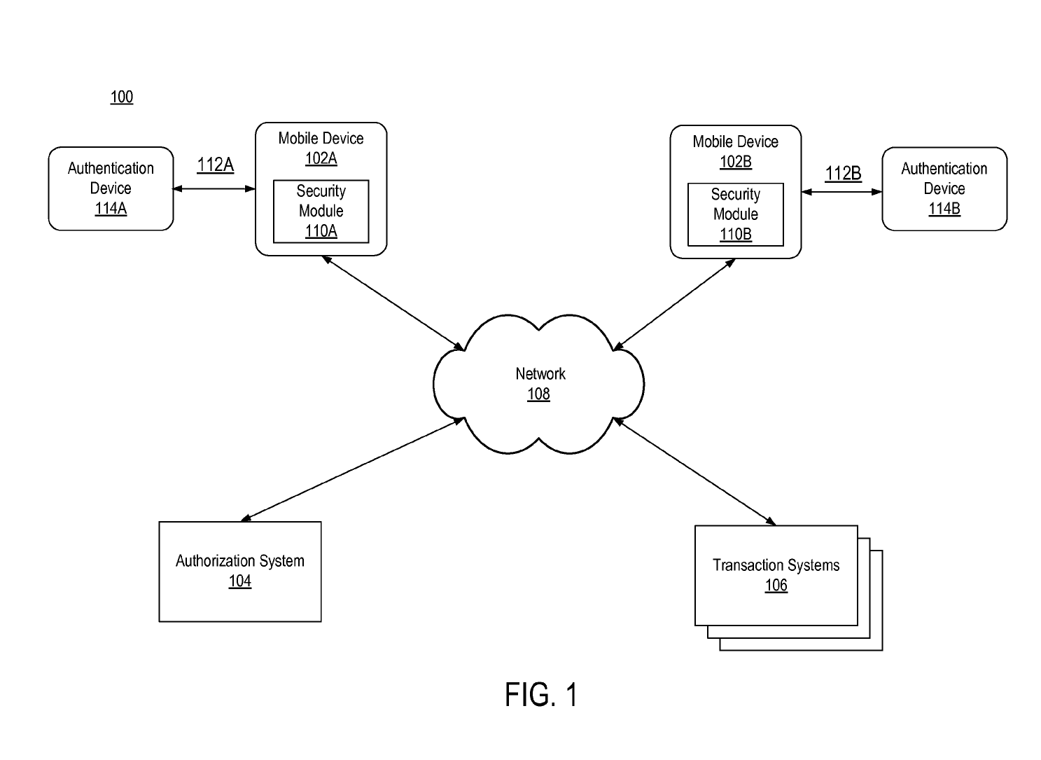

FIG. 1 is a block diagram of an authentication environment 100 according to one embodiment. FIG. 1 illustrates two mobile devices 102A and 102B, an authorization system 104 and multiple transaction systems 106. The devices 102 and systems 104 and 106 are connected via a network 108. Although the illustrated environment 100 includes only a select number of each entity, other embodiments can include more or less of each entity (e.g., additional mobile devices 102 and transaction systems 106).

FIG. 1 uses like reference numerals to identify like elements. A letter after a reference numeral, such as “102A,” indicates that the text refers specifically to the element having that particular reference numeral. A reference numeral in the text without a following letter, such as “102,” refers to any or all of the elements in the figures bearing that reference numeral (e.g. “102” in the text refers to reference numerals “102A” and “102B.”

A mobile device 102 is a mobile electronic computing device. The mobile device 102 may be, for example, a mobile phone, tablet computer, notebook computer, or personal digital assistant (PDA). The mobile device 102 includes a security module 110 that establishes a connection 112 between the mobile device 102 and an authentication device 114. The mobile device 102 and authentication device 114 are associated with the same user (e.g., both devices 102 and 114 may be owned and/or registered to the same user). The user typically carries both the mobile device 102 and the authentication device 114. For example, the user may have the authentication device 114 in his wallet and the mobile device 102 in his pocket or pursue.

The connection 112 established between the mobile device 102 and the authentication device 114 is a limited-range wireless communication link. Therefore, the mobile device 102 and the authentication device 114 can communicate as long as they are within range of each other. In one embodiment, the connection 112 is a Bluetooth connection, such as a Bluetooth low energy connection.

The authentication device 114 is a device capable of limited-range communication. In one embodiment, the authentication device 114 is in the form of a card that fits in a wallet (e.g., similar in shape to a credit card or smart card). The authentication device 114 may also include information about one or more financial accounts of the user. For example, the card may include financial account information (e.g., a credit card number) printed on it and a magnetic strip with stored financial account information. The authentication device 114 may be in other forms. For example, the authentication device 114 may be another mobile device (e.g., mobile phone, a tablet, a token/fob attached to a key ring) or a personal desktop computer.

After the connection 112 is established between the mobile device 102 and the authentication device 114, the authentication device 114 periodically transmits messages to the mobile device 102. For example, the authentication device 114 may transmit a message every 0.5 seconds. The message indicates to the mobile device 102 that the authentication device 114 is still within the range of the connection 112.

The security module 110 of the mobile device 102 generates authentication information based on the messages or lack of messages received from the authentication device 114. The security module 110 may, for example, generate the authentication information periodically (e.g., every 2 minutes or every third messages received) or after every message received from the authentication device 114.

The generated authentication information is information related to the connection 112 between the devices 102 and 114 and may be used in determining whether to authorize a transaction. The authentication information generated by the security module 110 may include, for example, a time and date when the last message was received from the authentication device 114, an IP address of the mobile device 102, whether the devices 102 and 114 are still connected via the connection 112, and a current geographic location of the devices 102 and 114. The security module 110 stores the generated authentication information and additionally transmits the information to the security module 110 so that it can be stored as historical authentication information.

In one embodiment, based on a message received or lack of message received from the authentication device 102, the security module 110 may determine that the authentication device 114 is not within a maximum distance from the mobile device 102. The maximum distance may be, for example, the maximum range of the connection 112 or a distance less than the maximum range of the connection. When the security module 110 determines that the authentication device 114 is not within a maximum distance from the mobile device 102, the security module 110 determines a geographic location where the authentication device 114 may be located. The determination of the location can be made, for example, based on the last message received by the mobile device 102 from the authentication device 114. The security module 110 presents an interface to the user that includes the determined geographic location.

The determined geographic location assists the user in locating the authentication device 114. As an example, assume the user has the authentication device 114 in his wallet, the mobile device 102 is in his pocket, and there is a connection 112 between the two devices. After dinner, the user walks out of a restaurant with his mobile device 102 but leaves behind his wallet at the restaurant table. As a result of the user leaving behind his wallet, the distance between the wallet/authentication device 114 and the mobile device 102 exceeds the maximum distance. When the user walks outside, the security module 110 may present an alert that the maximum distance has been exceeded and that the authentication device 114 is likely at the restaurant. Based on the message the user can then go back inside the restaurant and locate the wallet.

In one embodiment, through the interface presented to the user, the user can request to place one or more financial accounts of the user on hold (e.g., place credit card accounts and bank account on hold). A financial account may be placed on hold so that no transactions can be made using the account. If the user requests to place one or more accounts on hold, the security module 110 notifies the authorization system 104 to place the requested accounts on hold. The accounts may be placed on hold until authentication device 114 is located.

In one embodiment, the security module 110 is an application provided by the authorization system 110 to the mobile device 102. In another embodiment, the mobile device 102 obtains the security module 110 from a mobile application store. In one embodiment, in order for the user to use the features of the security module 110, the user has to create an account (i.e., sign-up) with the authorization system 104.

The authorization system 104 is an electronic system that receives authentication information from mobile devices 102 and processes requests from transaction systems 106 to authorize transactions. When the authorization system 104 receives authentication information from a mobile device 102 of a user, the authorization system 104 stores the information as historical authentication information. Historical authentication information is used in determining whether to authorize transactions.

When the authorization system receives from a transaction system 106 a request for authorization, the authorization system 104 identifies characteristics of the transaction (e.g., amount of transaction and type of transaction) and the user involved in the transaction (e.g., user whose account is part of the transaction). The authorization system 104 identifies one or more rules applicable to the transaction based on the transaction's characteristics. The rules that are applicable to a transaction are in various embodiments determined by the implementer, and may be for example based on the amount of risk to which the transaction exposes the user, the authorization system 104, and/or the transaction 106. For example, much stricter rules may be applied to a transaction of $3,000 than to a transaction of $5.

The authorization system 104 evaluates the conditions of the applicable rules and determines whether the conditions are satisfied. The authorization system 104 determines whether the conditions of one or more applicable rules are satisfied based on historical authentication information of the user. For example, two rules may be applied to the transaction. One rule may require that within the last hour the mobile device 102 and authentication device 114 were connected via the connection 112 for at least 50% of the time. The second rule may require that within the last 10 minutes the IP address of the mobile device 102 be the same as the IP address used to initiate the transaction. Based on the historical authentication information received from the mobile device 102, the security module 110 can determine whether the conditions of both rules are satisfied. If the two rules are satisfied, the authorization system 104 authorizes the transaction and informs the transaction system 106 to proceed. If the rules are not satisfied, in one embodiment the authorization system 104 notifies the transaction system 106 that the transaction should be declined. In alternative embodiments, authorization system 104 instructs the security module 110 of the mobile device 102 to obtain additional authentication information from the user—for example, by requiring entry of a PIN, a single-use or time-expiring key, or a gesture sequence at the mobile device. Following receipt of the additional authentication information, authorization system 104 then notifies the transaction system 106 that the transaction is authorized.

A transaction system 106 is an electronic system that processes transactions involving mobile device 102 and authentication device 114. In one embodiment, the transaction system 106 is the electronic system of a bank, a credit card company, a merchant, or a clearinghouse. In one embodiment, the processed transactions are financial transactions, such as transactions to purchase goods/services or transactions to transfer funds to a financial account. Transactions need not be financial in nature. For example, a processed transaction may be a request by a user to access his electronic account (e.g., a login transaction).

In one embodiment, when the transaction system 106 is processing a transaction, the transaction system 106 determines a user involved in the transaction. In one embodiment, a user is involved in a transaction if an account of the user (e.g., credit card account or bank account) is part of the transaction. The transaction system 106 determines whether the user involved in the transaction has an account with the authorization system 104. If the user has an account with authorization system 104, the transaction system 106 requests that the authorization system 104 determine whether to authorize the transaction.

The transaction system 106 processes the transaction based on the authorization determination made by the authorization system 104. In one embodiment, the transaction system 106 relies solely on authorization system's 104 determination in authorizing or declining the transaction. In another embodiment, the transaction system 106 considers the determination made by the authorization system 104 as a recommendation. The transaction system 106 uses the recommendation from the authorization system 104 along with other risk factors of the transaction and any additional business logic in determining whether to authorize or decline the transaction.

The network 108 represents the communication pathway between the mobile devices 102, the authorization system 104, and the transactions system 106. In one embodiment, the network 108 is the Internet and uses standard communications technologies and/or protocols. The network 108 can also utilize dedicated, custom, or private communications links that are not necessarily part of the Internet. The network 108 may comprise any combination of local area and/or wide area networks, using both wired and wireless communication systems.

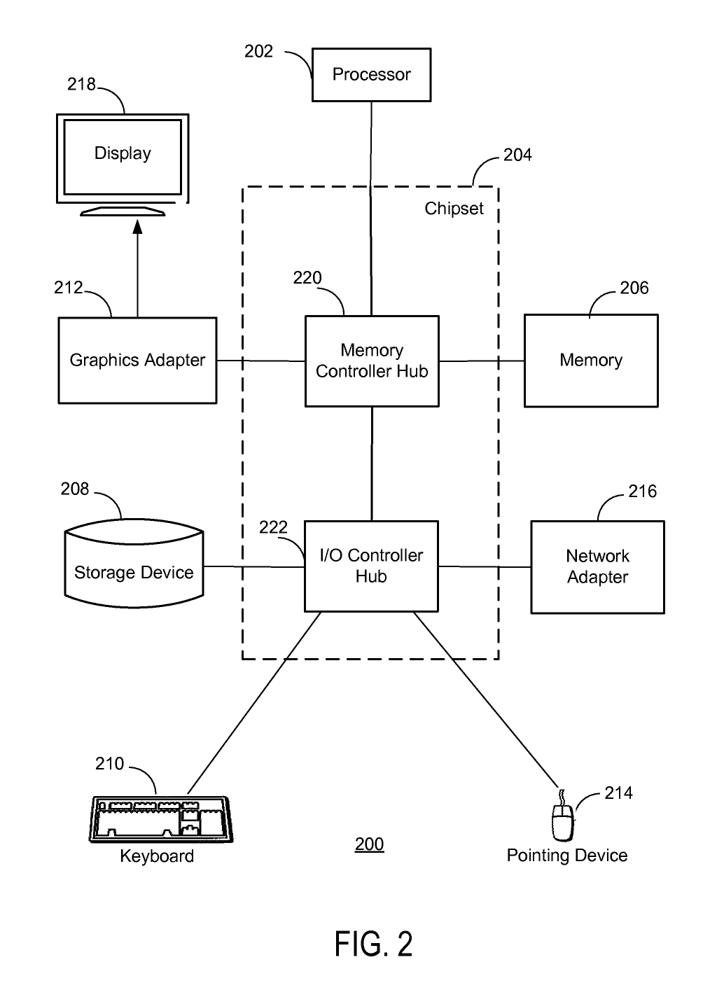

FIG. 2 is a block diagram illustrating a functional view of a typical computer system 200 for use as a mobile device 102, the authorization system 104 and/or a transaction system 106 according to an embodiment. Illustrated are at least one processor 202 coupled to a chipset 204. Also coupled to the chipset 204 are a memory 206, a storage device 208, a keyboard 210, a graphics adapter 212, a pointing device 214, and a network adapter 216. A display 218 is coupled to the graphics adapter 212. In one embodiment, the functionality of the chipset 204 is provided by a memory controller hub 220 and an I/O controller hub 222. In another embodiment, the memory 206 is coupled directly to the processor 202 instead of the chipset 204.

The storage device 208 is a non-transitory computer-readable storage medium, such as a hard drive, compact disk read-only memory (CD-ROM), DVD, or a solid-state memory device. The memory 206 holds instructions and data used by the processor 202. The pointing device 214 may be a mouse, track ball, or other type of pointing device, and is used in combination with the keyboard 210 to input data into the computer system 200. The graphics adapter 212 displays images and other information on the display 218. The network adapter 216 couples the computer system 200 to the network 108. Some embodiments of the computer system 200 have different and/or other components than those shown in FIG. 2. For example, a mobile device 102, such as a mobile phone may include additional components for Global Positioning System (GPS) location tracking and components to allow the device 106 to communicate via a mobile service provider network.

The computer system 200 is adapted to execute computer program modules for providing the functionality described herein. As used herein, the term “module” to refers to computer program instruction and other logic for providing a specified functionality. A module can be implemented in hardware, firmware, and/or software. A module is typically stored on the storage device 208, loaded into the memory 206, and executed by the processor 202.

A module can include one or more processes, and/or be provided by only part of a process. Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

The types of computer systems 200 used by the entities of FIG. 1 can vary depending upon the embodiment and the processing power used by the entity. For example, a user device 106 that is a mobile phone typically has limited processing power, a small display 218, and might lack a physical keyboard 210 and a pointing device 214. The authorization system 104 and the transaction system 106, in contrast, may comprise multiple blade servers working together to provide the functionality described herein.

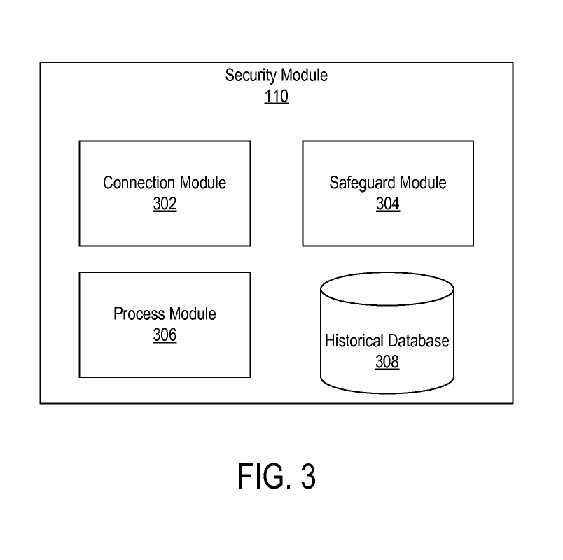

FIG. 3 is a block diagram illustrating modules within the security module 110 of a user's mobile device 102 according to one embodiment. The security module 110 includes a connection module 302, a safeguard module 304, a process module 306, and a historical database 308. Those of skill in the art will recognize that other embodiments can have different and/or other modules than the ones described here, and that the functionalities can be distributed among the modules in a different manner.

The connection module 302 manages a limited-range wireless connection between the user's mobile device 102 and the user's authentication device 114. The connection module 302 establishes the limited-range wireless connection between the mobile device 102 and the authentication device 114. In one embodiment, when establishing the connection, the connection module 302 indicates to the authentication device 114 to periodically send messages to the mobile device 102 (e.g., every 0.5 seconds) through the connection.

A message received by the mobile device 102 from the authentication device 114 indicates that the two devices 102 and 114 are still within the limited-range of each other. In one embodiment, in a message the authentication device may include one or more of the following: the time and date when the message was transmitted, a current geographic location of the authentication device 114, an Internet Protocol (IP) address of the device 114, a current temperature of the device 114, and an authentication key that verifies the authenticity of the authentication device 114.

In one embodiment, the authentication device 114 includes one or more accelerometers that detect the orientation of the device 114 and physical movements made with the device. In a message transmitted to the mobile device 102, the authentication device may include one or more of the following: a current orientation of the device 114 and an indication that the user recently performed a specific gesture/physical movement with the device 102 (e.g., tapping mobile device 102 with the authentication device 114, moving the authentication according to a specific pattern).

Once the connection has been established, the connection module 302 waits for the expected messages (e.g., every 0.5 seconds). The connection module 302 generates authentication information based on the messages or lack of messages received from the authentication device. Authentication information is information related to the connection between the devices 102 and 114 and which may be used in determining whether to authorize a transaction.

In one embodiment, the connection module 302 periodically generates authentication information (e.g., every 5^{th} message received). In one embodiment, the connection module 302 generates authentication information when the connection with the authentication device 114 is dropped (e.g., devices 114 and 110 become separated by more than the maximum range of the connection). In one embodiment, authentication information is generated by the connection module 302 when the connection is re-established after being dropped. The connection module 302 may also generate authentication information for every message received from the authentication device 114 and/or when the devices 102 and 114 become separated by more than a maximum distance that is less than the maximum range of the connection.

The authentication information generated by the connection module 302 may include one or more of the following: a time and date when the last message was received from the authentication device 114, information included in the last message received from the authentication device 114, an indication as to whether the devices 102 and 114 are currently connected via the limited-range connection, a current geographic location of the mobile device 102, an IP address of the mobile device 102, a current temperature of the mobile device 102, the signal strength of the last message received from the authentication device 114, and an estimated current distance between the devices 102 and 114. The connection module 302 stores the generated authentication information in the historical database 308 as historical authentication information. The connection module 302 also transmits the generated information to the authorization system 104 for storage as historical authentication information. As described in detail below, historical authentication information is used in determining whether to authorize transactions processed by transaction systems 106. In one embodiment, the authentication information transmitted to the authorization system 104 is encrypted and can only be decrypted with one or more keys stored by the authorization system 104.

The safeguard module 304 monitors whether mobile device 102 and the authentication device 114 are within a maximum distance of each other. In one embodiment, the maximum distance is the maximum range of the connection. In another embodiment, the maximum distance is less than the maximum range of the connection. The maximum distance may be set, for example, by the user of the mobile device 102 or by an administrator.

In the embodiment where the maximum distance is the maximum range of the connection, as long the mobile device 102 receives an expected message from the authentication device 114, the safeguard module 304 determines that the authentication device 114 is still within the maximum distance from the mobile device 102. However, if the mobile device 102 does not receive a certain number of expected messages from the authentication device 114 within a time period, the safeguard module 304 assumes that the connection has been dropped and that the authentication device 114 is no longer within the maximum distance from the mobile device 102.

In the embodiment where the maximum distance is less than the maximum range of the connection, if a certain number of expected messages are not received from the authentication device 114 within a time period, the safeguard module 304 automatically assumes that the connection has been dropped and that the distance between mobile device 102 and the authentication device 114 is greater than the maximum distance. When the mobile device 102 receives an expected message from the authentication device 114 via the connection, the safeguard module 304 estimates a current distance between the mobile device 102 and the authentication device 114.

The safeguard module 304 estimates the distance based on the received message. For example, the safeguard module 304 may estimate the distance based on the amount of time it took the mobile device 102 to receive the message after it was transmitted by the authentication device 114. As another example, the safeguard module 304 may estimate the distance based on the strength of the received message (e.g., strength in dBm). The safeguard module 304 compares the estimated distance to the maximum distance. If estimated distance is greater than the maximum distance, the safeguard module 304 determines that the authentication device 114 is no longer within the maximum distance from the mobile device 102.

When a determination is made that the authentication device 114 is not within the maximum distance from the mobile device 102, the safeguard module 304 determines a geographic location where the authentication device 114 maybe be located (a possible current location of the device 114). In one embodiment, the safeguard module 304 determines the possible current location to be one of the following: the geographic location of the mobile device 102 when the connection module 302 determined that the authentication device 114 was not within the maximum distance, the geographic location of the mobile device 102 when the mobile device 102 last received a message from the authentication device 114, or the geographic location of the authentication device 114 when the last message was received from the authentication device 114.

The safeguard module 304 presents an interface to the user that includes an alert that the authentication device 114 is not within the maximum distance from the mobile device 102. The safeguard module 304 also presents in the interface the determined possible location of the authentication device 114 so that the user can attempt to locate the device 114.

Through the interface the user may additionally request to place one or more of his financial accounts on hold. In one embodiment, by placing a financial account on hold, any transaction made using the account will be declined. Therefore, if an unauthorized person has the user's wallet (along with the authentication device 114) and tries to make a purchase with a credit card included in the wallet, the purchase transaction will be declined as long as the credit card account has been placed on hold. If the user requests to place one or more accounts on hold, the safeguard module 304 notifies the authorization system 104 to place the accounts on hold. At any time, the user can request to remove the hold on an account (e.g., after locating the authentication device 114). When the user requests to remove the hold on an account, the safeguard module 304 notifies the authorization system 104 to remove the hold.

The process module 306 performs authorization processes requested by the authorization system 104. Based on a request received by the authorization system 104 to determine whether to authorize a transaction, the authorization system 104 may request that the security module 110 perform an authorization process so that a determination can be made as to whether to authorize a transaction.

A request made by the authorization system 104 may be for current authentication information. When the authorization system 104 makes such a request, the process module 306 requests a message from the authentication device 114. Based on the authentication device's response to the request, the process module 306 generates the authentication information. The process module 306 transmits generated authentication information to the authorization system 104. The process module 306 also stores the authentication information in the historical device 308.

A request made by the authorization system 104 may be for the user to authorize a transaction being processed by a transaction system 106 by providing personal information, such as a personal identification number (PIN), a username and password for an account the user has with the authorization system 104 or the transaction system 106, or an answer to a security question. When the authorization system 104 makes such a request, the authorization system 104 provides information regarding the transaction to the mobile device 102. The process module 306 presents the transaction information to the user. The process module 306 additionally presents a message to the user indicating that if he wishes to authorize the transaction, the user must provide the personal information. If the user provides the personal information, the process module 306 provides the personal information to the authorization system 104.

A request made by the authorization system 104 may be to request from the user that he authorize a transaction by performing a gesture with the authentication device 114. The process module 306 presents transaction information to the user along with a message indicating that if he wishes to authorize the transaction, the user must perform a specific gesture with the authentication device 114 (e.g., tap the mobile device 102 with the authentication device 114 one or more times or wave the authentication device 114 over the mobile device 102.

If the authentication device 114 detects that the user performed the gesture, the authentication device 114 notifies the mobile device 102 via the limited-range connection. The process module 306 in turn notifies the authorization system 104 that the authorizing gesture was performed by the user.

The authorization system 104 may also request that an authorization process be performed to verify that the authentication device 114 is currently within the maximum distance from the mobile device 102. When the authorization system 104 makes the request, the process module 306 sends a message to the authentication device 114 via the connection established by the connection module 302. The message requests that the authentication device 114 immediately respond to the request by confirming receipt of the message.

Based on the response from the authentication device 114, the process module 306 determines whether the authentication device 114 is currently within the maximum distance. The process module 306 informs the authorization system 104 of the determination as to whether the devices 102 are 114 within the maximum distance of each other.

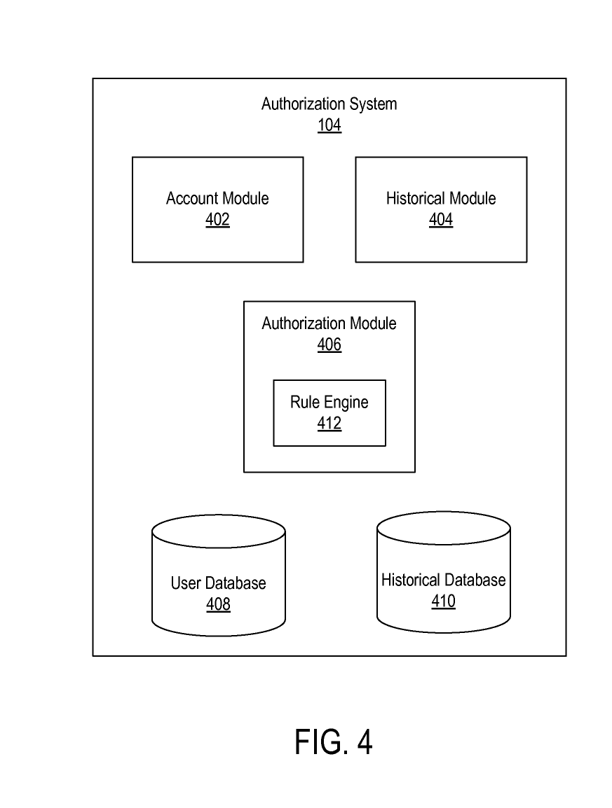

FIG. 4 is a block diagram illustrating modules within the authorization system 104 according to one embodiment. The authorization system 104 includes an account module 402, an information module 404, an authorization module 406, a user database 408, and a historical database 410. Those of skill in the art will recognize that other embodiments can have different and/or other modules than the ones described here, and that the functionalities can be distributed among the modules in a different manner.

The account module 402 allows users to create accounts with the authorization system 104. Creating an account with the authorization system 104 allows a user to use the features of the authorization system 104 and the security module 110. If a user has not previously created an account with the authorization system 104 and requests to create an account, the user goes through a sign-up process to create the account. In one embodiment, in the sign-up process, the user provides information as to his authentication device 114 and/or mobile device 102. For example, the user may provide an identification number of his authentication device 114 and a phone number of the mobile device 102.

In one embodiment, in the sign-up process, the user provides information as to one or more of his financial accounts. A financial account of a user is an account the user has with a financial institution, such as a bank or credit card company. In one embodiment, in the sign-up process, the user provides information of financial accounts that the user may want to place on hold if the authentication device 114 becomes separated from the mobile device 102 by more than the maximum distance. For example, the user may provide account information of credit cards and debit cards that the user carries in his wallet with the authentication device 114. The information provided by a user for a financial account may include, for example, the name of a financial institution that holds the account and an account number.

In one embodiment, in the sign-up process, the user indicates safe zones. A safe zone is a location/area that has been designated by the user as being safe. In a safe zone the user is not concerned, for example, about fraudulent transaction being initiated from that location. The user may designate, for example, his home and workplace as safe zones. In one embodiment, the user may also indicate danger zones where fraudulent transactions are likely to be initiated. The account module 402 stores the information received from the user through the sign-up process in the user database 408.

The historical module 404 processes authentication information received from the security modules 110 of mobile devices 102. When the authorization system 104 receives from a mobile device's security module 110 authentication information generated by the security module, the historical module 404 identifies the user associated with the mobile device 102. The historical module 404 identifies in the historical database 410 a historical log of the user and stores the authentication information in the historical database 410 as historical authentication information of the user. The historical database 410 includes a historical log for each user of the authorization system 104. A historical log includes at least a portion of the user's the historical authentication information.

The historical module 404 also processes requests from security modules 110 to place financial accounts on hold. In one embodiment, when the historical module 404 receives from a security module 110 a request to place a user's financial account on hold, the historical module 404 stores information in the historical log of the user in the database 410 that indicates that the account is on hold. In one embodiment, as long as the account is on hold, the authorization module 406 will decline a transaction being processed that involves the account.

In one embodiment, when the authorization system 104 receives from a security module 110 a request to place a user's financial account on hold, the historical module 404 determines the financial institution that holds the account based on information stored in the user database 408. The historical module 404 communicates with the financial institution and instructs the financial institution to the place the account on hold based on a request made by the user of the account. Further validation of the user's request may be required by the financial institution. If the authorization system 104 later receives a request to remove the hold on the financial account, the historical module 404 instructs the financial institution to remove the hold.

The authorization module 406 processes requests from transaction systems 106 for a determination as to whether to authorize transactions. Each transaction has an inherent degree of risk. For example, a transaction that involves transferring a large amount of money from one bank account to another bank account can be considered riskier than a transaction for the purchase of a snack at a café. The authorization system 104 enables an implementer to choose different rules to be applied in authorizing transactions depending on the perceived riskiness of the transaction. More stringent rules may require greater or more immediate authentication by the user, while more lenient rules may rely on historical information to authorize a transaction without additional user input.

The authorization module 412 includes a rule engine 412. The rule engine 412 stores rules that are selectively applied depending on the characteristics of a transaction. In various embodiments, different rules are selected depending on transaction characteristics such as an amount of the transaction, a type of the transaction (e.g., online purchase, credit card purchase, bank fund transfer), a location where the transaction was initiated (e.g., transaction initiated in a safe zone or danger zone), and a time when the transaction was initiated. As an example, one rule in the rule engine 412 may be applicable to online purchases that are over $1000 and another rule may be applicable to online purchases under $1000. As another example, one rule may be applicable to transactions initiated in a safe zone and another rule may be applicable to transactions that occur in a danger zone. In one embodiment, an implementer such as a system administrator of the authorization system 104 and/or a transaction system 106 determines the characteristics of transactions to which a rule is applicable.

When a request for authorization of a transaction is received from transaction system 106, the authorization module 406 identifies characteristics of the transaction (e.g., an amount of the transaction, type of the transaction, an account involved in the transaction) and the user involved in the transaction. Based on the characteristics of the transaction, the authorization module 406 identifies the rules of the rule engine 412 that are applicable to the transaction.

In one embodiment, the authorization module 406 applies each of the applicable rules. In another embodiment, the authorization module 406 applies the identified rules in stages. As an example, assume four rules are applicable. If conditions of rule 1 are satisfied, then rules 2 and 3 are applied. However, if the conditions of rule 1 are not satisfied, rule 4 is applied. In one embodiment, if multiple rules are applicable to the transaction, the authorization module 406 only applies the most restrictive/stringent rule.

The authorization module 406 evaluates the conditions of the applicable rules and determines whether the conditions of the rules are satisfied. In one embodiment, for one or more of the identified rules, the authorization module 406 determines whether the conditions of the rules are satisfied based on historical authentication information of the user. For a rule determined based on historical authentication information, the authorization module 406 retrieves the user's historical log from the historical database 410 and determines whether the conditions of the rule are satisfied based on the historical authentication information included in the log.

A rule determined based on historical authentication information may be an IP address rule. Based on historical IP address information of the user's mobile device 102 and/or authentication device 114, a determination is made as to whether an IP address rule is satisfied. For example, an IP address rule may be satisfied if the historical information indicates that within the last 5 minutes the IP address of the devices 102 and 114 has been the same as the IP address used to initiate the transaction. If the IP addresses are the same it means that the user likely initiated the transaction.

Another rule determined based on historical information may be a timing rule. Based on the timing of authentication information received from the mobile device 102, a determination is made as to whether the rule is satisfied. For example, a timing rule may be satisfied if the historical information indicates that authentication information was received from the mobile device 102 in the last 15 minutes. Satisfying this rule may provide some assurance that the authentication device 114 and the mobile device 102 were within limited range of each other in the last 15 minutes. Another rule determined based on historical authentication information may be a proximity rule that may be satisfied based on the proximity between the devices 102 and 114. For example, a proximity rule may be satisfied if the historical information indicates that the messages received by the mobile device 102 from the authentication device 114 in the last 5 minutes all had a signal strength above −40 dBM.

In one embodiment, a rule determined based on historical information is a location rule that may be satisfied based on the location of the mobile device 102 and/or authentication device 114. As an example, a location rule may be satisfied if the historical information indicates that within the last 10 minutes the devices 102 and 114 were within 1 mile of where the transaction was initiated. Other rules determined based on historical information may include motion rules (e.g., satisfied if historical information indicates the devices 102 and 114 are moving in a walking motion) and temperature rules (e.g., satisfied if historical information indicates the temperature of the devices has been near 38° C., which means the devices are close to a human body).

In one embodiment, for one or more of the identified rules, the authorization module 406 requests that the security module 110 of the mobile device 102 execute an authorization process. As described above with reference to process module 306, the authorization module 406 may request that the security module 110 perform one or more of the following processes: generate current authentication information, request that the user provide personal information (e.g., a PIN, password) to authorize the transaction, request that the user make a certain gesture with the authentication device 114 to authorize the transaction (e.g., tap the mobile device 102 with the authentication device 114), and verify that the authentication device 114 is within a maximum distance from the mobile device 102.

When information is received from the mobile device 102 regarding the authentication process executed by the security module 110, the authorization module 406 determines whether the rule is satisfied based on the received information. As an example, assume that the authorization module 406 is determining whether to authorize a high-risk transaction. A first rule applied to the transaction is satisfied based historical authentication information. However, because of the high risk of the transaction, a second rule may still be applied that requires the user to perform a certain gesture. If information is received from the mobile device 102 that indicates that the user performed the gesture to authorize the transaction, the authorization module 406 determines that the second rule is satisfied.

In one embodiment, the authorization module 406 determines to authorize the transaction if the conditions of every rule applied to the transaction are satisfied. If every rule is not satisfied, the authorization module 406 determines to decline the transaction.

In another embodiment, the authorization module 406 calculates a risk score to determine whether to authorize the transaction. The risk score is calculated based on the sum of points contributed by each rule applied to the transaction. The amount of points contributed by each rule is dependent on whether it was determined that the conditions of the rule are satisfied.

As an example, assume that three rules are applied to a transaction. If the conditions of a rule are satisfied 15 points are contributed towards the risk score. If the conditions of a rule are not satisfied 0 points are contributed towards the risk score. Assume that in this example only two of the three rules were satisfied by historical authentication information. In this example, the authorization module 406 would calculate a risk score of 30 points.

The authorization module 406 determines to authorize the transaction if the calculated risk score is above a threshold score. If the risk score is below the threshold score, the authorization module 406 determines to decline the transaction. In one embodiment, the threshold score is set by a system administrator.

In one embodiment, if an account involved in the transaction is currently on hold according to information stored in the historical database 410, the authorization module 406 automatically determines to decline the transaction and does not go through the process of applying rules to the transaction. The authorization module 406 notifies the transaction system 106 of its determination to authorize or decline the transaction.

Although the embodiments above, have described the authorization system 104 determining whether to authorize or decline transactions, in other embodiments a mobile device 102 may make the determination. Instead of a transaction system 106 sending a request to the authorization system 104 to authorize a transaction, the transaction system 106 sends the request to the mobile device 102 of a user involved in the transaction. The mobile device 102 applies the processes described above and uses the authentication information stored in the historical database 308 to determine whether to authorize or decline the transaction.

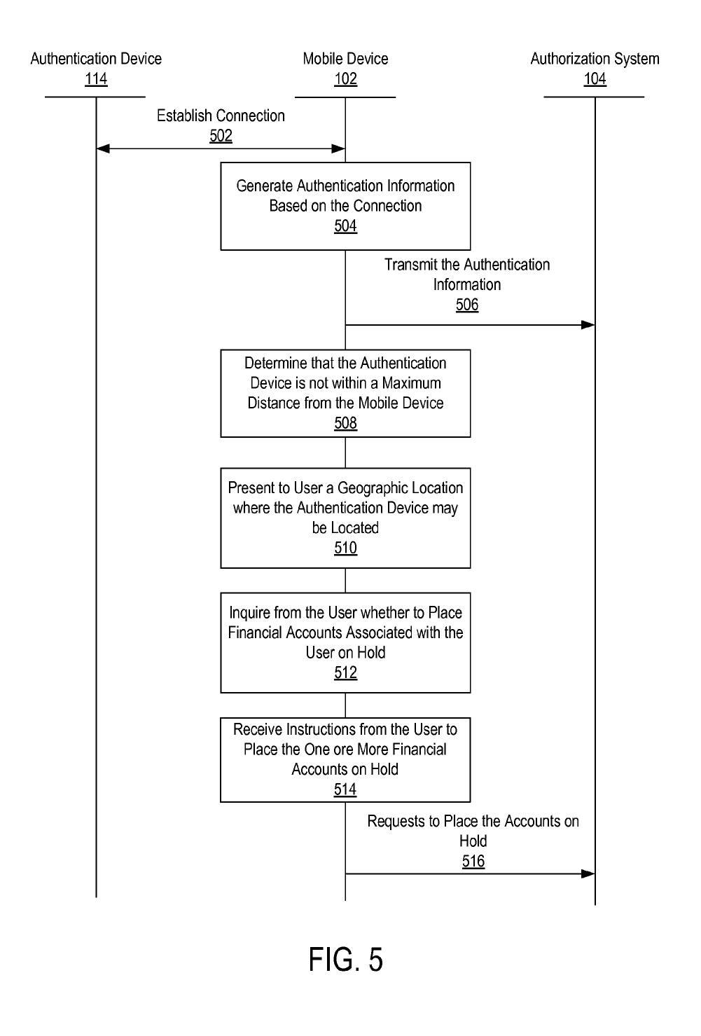

FIG. 5 illustrates an interaction diagram of a process for monitoring a limited-range connection between an authentication device 114 and a mobile device 102 according to one embodiment. The interaction diagram illustrates steps performed by the authentication device 114, the mobile device 102, and the authorization system 104 during the process. Those of skill in the art will recognize that other embodiments can perform the steps of FIG. 5 in different orders. Moreover, other embodiments can include different and/or additional steps than the ones described herein.

The authentication device 114 and the mobile device 102 establish 502 a limited-range connection between the two devices. The mobile device 102 periodically generates 504 authentication information based on the connection and transmits 506 the authentication information to the authorization system 104.

If the mobile device 102 determines 508 that the authentication device 114 is not within a maximum distance from the mobile device 102, the mobile device 102 presents 510 to a user of the device 102 a geographic location where the authentication device 114 may be located. The mobile device 102 inquires 512 from the user whether he would like to place financial accounts associated with the user on hold. The mobile device 102 receives 514 instructions from the user to place one or more financial accounts on hold. The mobile device 102 requests 516 from the authorization system 104 to place the one or more accounts on hold.

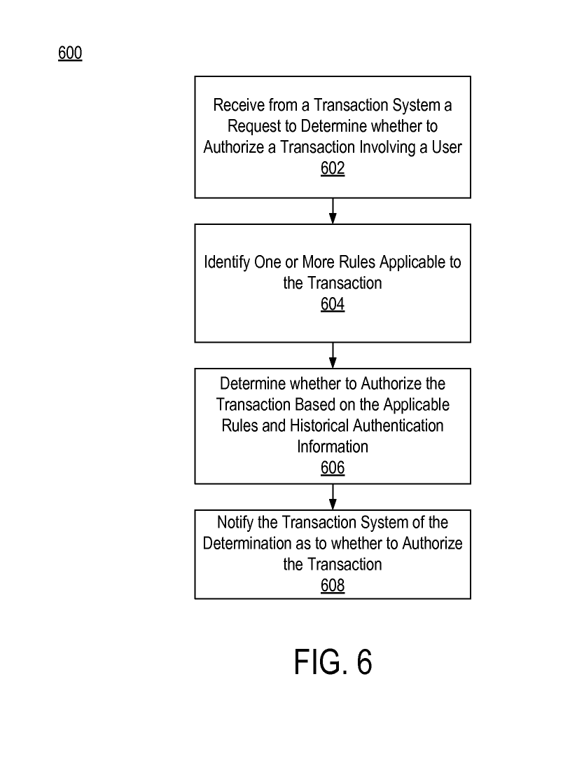

FIG. 6 is a flowchart 600 illustrating steps performed by the authorization system 104 in processing a request to determine whether to authorize a transaction according to one embodiment. Those of skill in the art will recognize that other embodiments can perform the steps of FIG. 6 in different orders. Moreover, other embodiments can include different and/or additional steps than the ones described herein.

The authorization system 104 receives 602 from a transaction system 106 a request to determine whether to authorize a transaction involving a user. The authorization system 104 identifies 604 one or more rules applicable to the transaction. The authorization system 104 determines 606 whether to authorize the transaction based on the applicable rules and historical authentication information of the user. The authorization system 104 notifies 608 the transaction system 106 of the determination as to whether to authorize the transaction.

According to one embodiment, the authorization system 104 receives a request from a transaction system 106 to authorize a transaction involving a user of a mobile device 102. The authorization system 104 determines whether the mobile device 102 is within a maximum allowable range of an authentication device 114 of the user. If the mobile device 102 is within the maximum allowable range of the authentication device 114, the authorization system 104 authorizes the transaction. If the mobile device 102 is not within the maximum allowable range of the authentication device 114, the authorization system 104 identifies at least one rule applicable to the transaction. The authorization system 104 determines whether the applicable rule is satisfied based on historical information describing a limited-range connection between the mobile device 102 and the authentication device 114. If the applicable rule is satisfied, the authorization system 104 authorizes the transaction.

In various embodiments, authentication device 114 is powered by a battery that may be either rechargeable or single use. To prolong the length of the battery, in some embodiments authentication device 114 communicates with mobile device 102 infrequently—for example, only when necessary to determine whether the devices are proximate to each other at authorization time (i.e. on request from authorization system 104). In some embodiments, the frequency with which the devices communicate is adjustable by the implementer and, where appropriate, rule engine 412 is similarly adaptable to take into account the expected communication frequency between the devices.

Some portions of above description present the features of embodiments in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments could be embodied in software, firmware or hardware, and when embodied in software, could be downloaded to reside on and be operated from different platforms used by real time network operating systems.

The disclosure of the embodiments is intended to be illustrative, but not limiting, of the full scope of the embodiments, which is set forth in the following claims.

We claim:

1. A computer-implemented method for authorizing a user transaction, the method comprising:
receiving, by a computer system from a transaction system via a network, a request to authorize a transaction involving a user of a mobile device;
determining whether the mobile device is within a maximum allowable range of an authentication device;
responsive to the mobile device being within the maximum allowable range of the authentication device, authorizing the transaction;
responsive to the mobile device not being within the maximum allowable range of the authentication device:
identifying at least one rule applicable to the transaction;
determining, according to historical information describing a connection between the mobile device and the authentication device, whether the applicable rule is satisfied; and
responsive to the applicable rule being satisfied, authorizing the transaction.

2. The method of claim 1 further comprising:
responsive to the applicable rule not being satisfied:
sending a request to the user to perform an additional authentication action; and
responsive to receiving an indication that the user performed the additional authentication action, authorizing the transaction.

3. A computer-implemented method for authorizing a transaction, the method comprising:
receiving, by a computer system from a transaction system via a network, a request to authorize a transaction involving a user of a mobile device;
determining, by the computer system, whether to authorize the transaction based on historical authentication information generated prior to receiving the request and generated based on communication between an authentication device and a mobile device via a limited-range connection; and
notifying the transaction system, by the computer system, of the determination as to whether to authorize the transaction.

4. The method of claim 3, wherein determining whether to authorize the transaction comprises:
identifying one or more rules applicable to the transaction;
determining whether conditions of the applicable rules are satisfied, wherein for at least one of the applicable rules, the determination is made based on the historical authentication information; and
determining whether to authorize the transaction based on the determination as to whether the conditions of the applicable rules are satisfied.

5. The method of claim 4, wherein determining whether conditions of the applicable rules are satisfied further comprises:
requesting from the mobile device, based on an applicable rule, that the user provide personal information to authorize the transaction; and
responsive to receiving the personal information, determining that one or more conditions of the applicable rule are satisfied based on the personal information.

6. The method of claim 5, the personal information comprises one or more of the following: a personal identification number, a username, a password, and an answer to a security question.

7. The method of claim 4, wherein determining whether conditions of the applicable rules are satisfied further comprises:
requesting from the mobile device, based on an applicable rule, that the user perform one or more movements with the authentication device;
receiving information from the mobile device indicating whether the user performed the movements; and
determining whether one or more conditions of the applicable rule are satisfied based on the received information.

8. The method of claim 4, further comprising:
calculating a risk score based on whether the conditions of the applicable rules are satisfied; and
determining whether to authorize the transaction based on the risk score.

9. The method of claim 3, wherein the historical authentication information is generated by the mobile device based on one or more messages received by the mobile device from the authentication device via the limited-range connection.

10. The method of claim 3, wherein the historical authentication information is generated by the mobile device based on one or more expected messages not being received by the mobile device from the authentication device via the limited-range connection.

11. The method of claim 3, wherein the historical authentication information includes one or more of the following: a time and date when a message was received by the mobile device from the authentication device, an indication as to whether the limited-range connection was active at a certain time, a geographic location of the mobile device at a certain time, and an IP address of the mobile device at a certain time.

12. The method of claim 3, further comprising:
responsive to determining that an account involved in the transaction has been placed on hold by the user, determining to deny the transaction.

13. A computer-implemented method comprising:
establishing, by a mobile device, a limited-range connection with an authentication device, the mobile device and the authentication device associated with a user;
generating, by the mobile device, authentication information based on the limited-range connection; and
transmitting, by the mobile device, the authentication information to an authorization system, wherein the authorization system determines whether to authorize a transaction based on the authentication information.

14. The method of claim 13, wherein the authentication information is generated based on one or more messages received by the mobile device from authentication device via the connection.

15. The method of claim 13, wherein the authentication information is generated based on one or more expected messages not being received by the mobile device from authentication device via the connection.

16. The method of claim 13, wherein the authentication information includes one or more of the following: a time and date when a message was received by the mobile device from the authentication device, an indication as to whether the limited-range connection was active at a certain time, a geographic location of the mobile device at a certain time, and an IP address of the mobile device at a certain time.

17. The method of claim 13, further comprising:
monitoring whether the authentication device is within a maximum distance of the mobile device via the connection;
responsive to determining that the authentication device is not within the maximum distance of the mobile device, determining a geographic location of the authentication device; and
presenting the determined geographic location to the user.

18. The method of claim 17, wherein the determined geographic location is a geographic location of the mobile device when determining that the authentication device is not within the maximum distance of the mobile device.

19. The method of claim 17, wherein the determined geographic location is a geographic location of the mobile device when the mobile device received a last message from the authentication device prior to determining that the authentication device is not within the maximum distance of the mobile device.

20. The method of claim 17, wherein the determined geographic location is a geographic location of the authentication device when the mobile device received a last message from the authentication device prior to determining that the authentication device is not within the maximum distance of the mobile device.

21. The method of claim 13, further comprising:
monitoring whether the authentication device is within a maximum distance of the mobile device via the connection;
responsive to determining that the authentication device is not within the maximum distance of the mobile device, presenting an interface through which the user may request to place a financial account associated with the user on hold; and
responsive to the user requesting to place the financial account on hold, communicating with the authorization system to place the account on hold.

22. A computer-implemented method comprising:
receiving, by a mobile device from a transaction system, a request to determine whether to authorize a transaction involving a user;
determining, by the mobile device, whether to authorize the transaction based on historical authentication information generated prior to receiving the request and generated based on communication between an authentication device and the mobile device via a limited-range connection; and
notifying the transaction system, by the mobile device, of the determination as to whether to authorize the transaction.
